(19) United States
(12) Patent Application Publication
(10) Pub. No.: US 2016/0357034 A1
(43) Pub. Date: Dec. 8, 2016

(54) Colour Changing Articles

(71) Applicant: Andrew Pothier, Toronto (CA)

(72) Inventor: Andrew Pothier, Toronto (CA)

(21) Appl. No.: 15/173,681

(22) Filed: Jun. 5, 2016

(30) Foreign Application Priority Data
Jun. 8, 2015 (CA) 2893516

(51) Int. Cl. G02F 1/01; G02F 1/00; D02J 1/22; D02G 3/44; D02G 3/36

(52) U.S. Cl. CPC G02F 1/0131; D02G 3/44; D02G 3/36; D02J 1/227; G02F 1/0072; D10B 2401/061; D10B 2501/00; D10B 2509/00; G02F 2202/36

(57) ABSTRACT

Articles comprising fibres that change colour when they are stretched, thereby giving an indication of the tension being applied to the article. The present invention can be used with a variety of articles which require tension to be applied to achieve maximum functionality. These articles can include garments, such as compression garments, shirts, shorts, pants, socks, underwear, or hats; bandages, such as compression bandages; shoelaces; shoes; securities, sutures, ropes or cables.

### FIELD OF THE INVENTION

The present invention relates to articles that change colour when placed under tension.

### BACKGROUND OF THE INVENTION

There are numerous situations in which the user of an article wishes to apply tension to the article in a predetermined range so as to maximize effectiveness of the article. In some cases, too much or too little tension can negatively affect the performance of the article, and by extension, the user. Examples of these situations include tying shoelaces, wearing of compression garments, and application of compression bandages. In some situations, such as tightening shoelaces, the articles will repeatedly have tension applied and there is a desire for the same amount of tension to be applied every time. In other situations, the user may desire to apply different tension to the article based on the situation in which the article is being used, such as the application of sutures to different types of tissue or compression bandages to different body parts.

Various attempts have been made in attempt to indicate the tension of articles that are to be stretched. U.S. Pat. No. 5,779,659, U.S. Pat. No. 6,050,967 and U.S. Pat. No. 3,613,679 disclose elastic bandages with geometric patterns woven into the material of the bandage that change as the bandage is stretched, the deformation of the pattern indicating to the user how much the material has been stretched. US Patent Application 2013/0319128 disclosed tension indicating system comprising an upper layer is mounted on a base layer such that indicia on the base layer moves relative to the upper layer, the relative movement indicating the amount of tension being applied.

There have also been numerous devices developed to aid a user in applying a desired amount of tension to shoelaces. Examples include U.S. Pat. No. 889,770, U.S. Pat. No. U.S. Pat. No. 5,903,959, US Patent 2014/0000074, and U.S. Pat. No. 5,469,640. These devices are typically used in addition to the typical shoe and lace system, thereby adding complexity and cost.

These prior art attempts all bring with them disadvantages relating to the complexity and cost they add to the manufacture and use of the systems.

### SUMMARY OF THE INVENTION

There has now been devised improved forms of articles which overcomes or substantially mitigates the above-mentioned disadvantages.

Recent innovations in material science have created materials, such as the fibres disclosed by Kolle et al. in Bio-Inspired Band-Gap Tunable Elastic Optical Multilayer Fibers (Kolle et al. (2013), Adv. Mater., 25: 2239-2245. doi: 10.1002/adma.201203529) and the elastomeric sheet disclosed by Nozawa in “Iridescent Rubber Sheet Visualizes Stress Applied to It”, Nikkei Technology, Nikkei Business Publications, 12 Feb., 2015, 2 Mar. 2015, <http://techon.nikkeibp.co.jp/english/NEWS_EN/20150212/403780/?n_cid=nbptec_tecrs>, that change colour when under tensile load. The materials of Kolle and Nozawa use structural colouration to achieve their effects. As the materials are put under stress, the microstructural elements of the materials change, causing a change to the wavelength of the reflected light. The fibres of Kolle et al. comprise a bilayer arrangement dielectric materials, whose peak reflection wavelengths shifts as the tensile load is applied, producing a visible colour changing effect. The elastomer of Nozawa comprise colloidial nanoparticles dispersed throughout an elastomeric sheet. As force is applied to the sheet, the spacing between the nanoparticles change, causing the wavelength of the reflected light to change. The nanoparticles can be periodically arranged in the elastomeric sheet, such as in an ordered periodic array.

By incorporating these materials, in the form of fibres, threads, filaments or the like, in articles which are designed to have tensile forces applied to them during normal use, users can easily determine the amount of tension being applied to these articles so that they can repeatably apply the same amount of tension the article.

The present invention can be used with a variety of articles which require tension to be applied to achieve maximum functionality. These articles can include garments, such as compression garments, shirts, shorts, pants, socks, underwear, sleeves, or hats; bandages, such as compression bandages; shoelaces; shoes; sutures, ropes or cables.

Unlike the above mentioned the prior art, the present invention does not add any complexity to the manufacturing of these articles as no special patterns have to be incorporated into the article. Rather, the materials can easily be substituted into current manufacturing processes for these articles without any retrofitting. Furthermore, no added components are required for a user to make use of the present invention.

### DETAILED DESCRIPTION

Articles such as those mentioned above are and their methods of use and manufacture are commonly known and understood by those skilled in the art, and a detailed explanation thereof is not necessary for purposes of describing the articles and methods of the present invention.

Using commonly known manufacturing processes, one or more fibres that change colour when a tensile load is applied are used to make the article such that they are visible to the user of the article. For example, the fibre can be incorporated in systems that produce nonwoven fabrics, woven textiles, paper, bank note stock or ropes, and can be randomly or uniformly distributed through the article, or formed into a predetermined pattern. The pattern could range from simple singular lines to complicated patterns such as geometric patterns or words, such a brand name. The material of the rest of the article can be any material that would be considered suitable to the article by a person skilled in the art. For instance, a compression bandage could comprise elastic threads formed of a combination of latex, latex-free material, elastomer, cotton or any other material suitable for contact with the human body. The fibres are arranged in the article such that when a tensile load is applied, at least part of the force is transmitted to the fibres in a manner that causes an axial strain to be produced in the fibre. The resulting axial strain deforming the fibre and causing the colour of the fibre to change. In one embodiment, the colour changing fibres run from one end of a shoelace to the other. Another embodiments include fibres woven into the fabric of compression bandage or garment. A further embodiment includes the incorporation of the colour changing fibres into the substrate of a security, such as a bank note, stock, bond, certificate, passport, deed or the like, as an anti-fraud device. Users pull on any two opposing sides of the security, the change in colour exhibited by the fibres serving to verify the authenticity of the security.

In use, a user applies a tensile force to article, such as when tying a shoelace or applying a compression bandage, until the fibres change from a first colour to a second colour, the second colour being associated with the desired amount of tension. The user then secures the article in place, such as by tying shoe laces or applying retention means such as clasps to a compression bandage, so that the article remains under the desired load.

The first and second colours can be any colour in the visible spectrum. The wavelength of the second colour can either be longer or shorter than the wavelength of the first colour.

The colour associated with the desired amount of tension can be known to the user through a variety of means, such as experience gained through repeatedly applying the articles to determine what colour is associated with the desired amount of tension, through information given to the user, such as a card showing colour and associated tension loads, measured using appropriate testing equipment, or found on the internet.

A further embodiment of the invention comprises using the colour changing fibre in its unstretched state as a service life indictor. As an article creeps during its lifetime, the colour changing fibres elongate. When this happens, the microstructural elements that produce the colour changing effects move relative to each other, causing the colour of the fibre to change colour as the article creeps. For articles that have a useful service life defined by their elongation, this colour change can be used to determine whether the article is still within a previously determined range of acceptable elongation. For example, over the lifetime of a cord, its natural, unstretched state becomes longer. Colour changing fibers could be incorporated into the cord, as the colour changing naturally elongate with the cord, their colours will change. The producer of the cord could include with the cord a guide to the colours, which had been previously determined, that indicted that the cord was still useful. Once a certain colour is reached, the user will know that the cord has reached the end of its useful life.

It is envisioned that the colour changing fibres can be used in any kind of article where it would be desirable to have an indication of the tensile forces being applied. As such, many modifications and other embodiments of the invention set forth herein will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

1. An article comprising at least one fibre that changes colour when a tensile force is applied.

2. The article of claim 1, wherein when the article is in an unstretched state, the fibre is a first colour, and when the article is in a stretched state, the fibre is a second colour, and the wavelength of the first colour is longer than the wavelength of the second colour, or the wavelength of the first colour is shorter than the wavelength of the second colour.

3. The article of any one of claim 1, wherein the wavelengths are wavelengths of visible spectrum.

4. The article of claim 1, wherein the at least one fibre is elastic, transparent, translucent or opaque.

5. The article of claim 1, wherein the at least one colour changing fibre is aligned with the direction of the applied tensile force.

6. The article of claim 1, wherein the at least one colour changing fibre comprises a material with structural colouration properties.

7. The article of claim 1, wherein the at least one colour changing fibre comprises a bilayer material.

8. The article of claim 7, wherein each layer of the bilayer material comprises a dielectric material.

9. The article of claim 8, wherein each dielectric material is an elastic dielectric material.

10. The article of claim 1, wherein the at least one colour changing fibre comprises a material exhibiting structural colouration.

11. The article of claim 10, wherein the material comprises microstructures arranged to reflect light at a different wavelength than the incident light.

12. The article of claim 11, wherein the material comprises a colloidal elastomeric compound.

13. The article of claim 12, wherein the colloidal elastomeric compound comprises nanoparticles periodically arranged in an elastomeric sheet.

14. The article of claim 13, wherein the periodically arranged nanoparticles are arranged in an ordered periodic array, or the nanoparticles are sized and spaced to reflect light at least two wavelengths.

15. The article of claim 14, wherein the at least two wavelengths are wavelengths of visible spectrum.

16. The article of claim 1, wherein the at least one fibre comprises a plurality of colour changing fibres, the plurality of colour changing fibres being distributed uniformly, unevenly or randomly throughout the article, or are arranged to form a pattern.

17. The article of claim 1, wherein the article is a woven article, a non-woven article, a garment, a compression garment, a shirt, shorts, pants, socks, underwear, hat, bandage, compression bandage, shoe lace, shoe, suture, cord, rope, a security, bank note, stock, bond, certificate, passport, or a deed.

18. The article of anyone of claim 1, wherein the article has a service life defined by said article's elongation, use of the colour of the colour changing fibre in its unstretched state to determine if the article is acceptable for use.

19. A method of applying a desired amount of tension to an article comprising fibres that changes colour, the method comprising:
apply a tensile force to the article until the colour changing fiber is a colour that is known to be associated with the desired amount of tension, and
fix the article such that the desired tensile force is maintained.

20. Use of a colour changing fiber as an anti-fraud device in a security, or as a service life indictor in an article to which a tensile force is applied in the course of use of the article.
